(19) United States
(12) Patent Application Publication
(10) Pub. No.: US 2024/0013118 A1
(43) Pub. Date: Jan. 11, 2024

(54) AUTOMATED CHANGE ORDER RISK DETECTION AND ASSESSMENT

(71) Applicant: Capital One Services, LLC, McLean, VA (US)

(72) Inventors: Amy Shen, Plano, TX (US); Robert D. Blanchard, Henrico, VA (US)

(21) Appl. No.: 17/811,754

(22) Filed: Jul. 11, 2022

(51) Int. Cl. G06Q 10/06

(52) U.S. Cl. CPC G06Q 10/0635

(57) ABSTRACT

Systems, methods, and apparatuses for automatically determining levels of risk and significance for change orders are described. A machine-learning model may be trained to determine a level of risk associated with a change order for a configuration item. The change order comprising incident details associated with an incident may be received. The change order may be parsed, using the machine-learning models. Parsing the change order may include classifying terms in the incident details. Based in part on the change order and the machine-learning models, the level of risk associated with the change order may be determined. Furthermore, based in part on the level of risk associated with the change order, actions to address the incident may be determined.

### FIELD OF USE

Aspects of the disclosure relate generally to an automated method of detecting risks associated with change orders and determining appropriate actions based on the risk. More specifically, aspects of the disclosure provide for the automatic intake of information in order to process information using machine learning systems that are trained to detect a level of risk and significance associated with change orders and generate output that is used to perform actions associated based on the level of risk and significance.

### BACKGROUND

Processing change orders may be time consuming and may involve a large amount of manual review and processing. Additionally, in a fast paced environment, delaying processing of a change order may introduce issues that would not arise if the change order were more expeditiously processed. Further, some change orders may require immediate action while others are less important and may be delayed or not acted upon at all. However, the process of distinguishing change orders that may present issues that need to be addressed from change orders that present fewer issues may consume a large amount of time and resources. The time and resources needed to distinguish pressing change orders from less pressing change orders might be reduced if there were a way to automatically perform that process and make that decision. Accordingly, there is a need for a more effective way to detect process change orders and provide appropriate actions when needed.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may address these and other problems, and generally improve the effectiveness with which change order risk and significance are detected and assessed in order to provide appropriate action.

Aspects described herein may allow for automatic methods, systems, and apparatuses to detect change order risk and significance and determine appropriate action. Further, the aspects described herein may allow for automatic methods, systems, and apparatuses to detect the change order risk and significance. This may have the effect of detecting change orders that present a high risk of causing or exacerbating an incident that could prove costly. By proactively detecting high risk change orders before the scale and costs of issues increases, the disclosed technology may reduce the incidence of significant incidents that reduce the efficiency with which computing systems operate. According to some aspects, these and other benefits may be achieved by using a machine learning model that is trained to detect the risks associated with change orders and also determine the significance of the change order, thereby allowing for the generation of actions that may be taken when the risk and/or significance exceed respective thresholds. In implementation, this may be effectuated by using large datasets of historical change records to train the machine learning model to detect the risks and significance of change orders. These datasets may include historical change records that were previously resolved. Furthermore, the machine learning models may be periodically trained using updated datasets based on more recent change records, thereby allowing for improved accuracy of risk detection and significance determination that is based on more recent information.

More particularly, some aspects described herein may provide a computer-implemented method for detecting change order risk and significance. The computer-implemented method may comprise training, using a dataset comprising historical change orders, one or more machine-learning models to determine a level of risk associated with a change order for a configuration item. The computer-implemented method may comprise receiving, by a computing device, a change order comprising incident details associated with an incident. The computer-implemented method may comprise parsing, by the computing device, using the one or more machine-learning models, the change order. Parsing the change order may comprise classifying one or more terms in the incident details. The computer-implemented method may comprise determining, by the computing device, based in part on the change order and the one or more machine-learning models, the level of risk associated with the change order. Furthermore, the computer-implemented method may comprise determining, by the computing device, based in part on the level of risk associated with the change order, one or more actions to address the incident.

Further, the computer-implemented method may comprise determining the level of risk by comparing, by the computing device, using the one or more machine-learning models, the one or more values to one or more historical values of one or more corresponding historical fields associated with the historical change orders. Further, determining the level of risk may comprise determining, by the computing device, based on the comparison of the one or more values to the one or more historical values, an amount of similarity between the change order and the historical change orders. Further, determining the level of risk may comprise determining, by the computing device, the level of risk based in part on an extent to which the one or more values of the change order are similar to the one or more historical values of the historical change orders. In some instances, the computer-implemented method may comprise determining the level of risk by comparing the level of risk to a risk threshold. Further, determining the level of risk may comprise determining that a first action of the one or more actions may be performed if the level of risk is greater than or equal to the risk threshold. Further, determining the level of risk may comprise determining that a second action of the one or more actions may be performed if the level of risk is less than the risk threshold. The first action may comprise sending the change order to one or more computing devices associated with a change management analysis group and the second action may comprise determining by the one or more machine-learning models, implementation details of the second action to resolve the incident.

According to some aspects described herein, the computer-implemented method may comprise parsing the change order by applying one or more key term criteria to one or more terms of the change order, wherein the terms comprise one or more words or one or more numeric values. Further, parsing the change order may comprise determining, one or more key terms based in part on the one or more terms that satisfy the one or more key term criteria. The one or more key term criteria may comprise a frequency of the one or more terms exceeding a term frequency threshold and/or the one or more terms matching one or more incident key terms.

According to some aspects described herein, the computer-implemented method may comprise training, using a dataset comprising historical change orders, one or more machine-learning models to determine a level of significance associated with the change order for the configuration item. The level of significance may be associated with a number of users impacted by the change order or an estimated cost associated with the change order. Further, the computer-implemented method may comprise determining, by the computing device, using the one or more machine-learning models, a level of significance of the incident. The one or more actions may be based in part on the level of significance of the incident. Further, the level of significance of the incident may be based in part on the one or more terms. Further, the one or more terms may be associated with one or more significance values and the level of significance of the incident may be positively correlated with a frequency of occurrence of the one or more terms and/or an aggregate of the one or more significance values of the one or more terms.

According to some aspects described herein, the computer-implemented method may comprise training the one or more machine-learning models by performing, by the computing device, using the one or more machine-learning models, a trend analysis of the historical change orders. In some instances, the computer-implemented method may comprise training the one or more machine-learning models by determining, by the computing device, one or more occurrences of one or more events associated with historical incidents in the historical change orders. Further, training the one or more machine learning models may comprise correlating the one or more events with the level of risk of the historical change orders. In some instances, the one or more machine-learning models may use one or more natural language processing techniques to parse the historical change orders or the change order.

Further, the computer-implemented method may comprise comparing the level of risk to a risk threshold; determining that a first action of the one or more actions may be performed if the level of risk is greater than or equal to the risk threshold; and determining that a second action of the one or more actions may be performed if the level of risk is less than the risk threshold.

According to some aspects described herein, the computer-implemented method may comprise receiving, by the computing device, feedback associated with the one or more actions, wherein the feedback comprises an indication of which of the one or more actions were implemented or results associated with the one or more actions. Further, the computer-implemented method may comprise training the one or more machine-learning models based at least in part on the feedback.

Corresponding apparatuses, devices, systems, and computer-readable media (e.g., non-transitory computer readable media) are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing system that may be used to implement one or more aspects of the disclosure in accordance with one or more illustrative aspects discussed herein;

FIG. 2 illustrates an example of a change order form according to one or more aspects of the disclosure;

FIG. 3 illustrates an example of training a machine-learning model and detecting change order risk according to one or more aspects of the disclosure;

FIG. 4 illustrates an example flow chart for a method of detecting change order risk and significance according to one or more aspects of the disclosure;

FIG. 5 illustrates an example flow chart for a method of training machine-learning models in accordance with one or more aspects described herein;

FIG. 6 illustrates an example flow chart for a method of determining a level of risk and a level of significance for a change order according to one or more aspects of the disclosure; and

FIG. 7 illustrates an example flow chart for a method of performing actions based on a level of risk according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

The process of reviewing change orders may be arduous and require a great deal of manual review and input. In some cases, after a change order is flagged it is submitted to a review committee following multiple layers of review. Further, the change order may sit in a queue waiting to be reviewed while the risks associated with the change order accrue as a result of the change order not being reviewed. In particular, time sensitive change orders in which an issue with a configuration item needs to be addressed without undue delay are especially vulnerable to inefficiencies in the change order review process. To reduce the risks that result from unattended change orders or change orders that were not appropriately handled, the aspects discussed herein may, for example, use machine-learning models to determine levels of risk and levels of significance associated with change orders. The machine-learning models may be configured and/or trained to more accurately detect high risk change orders and/or change orders that would result in excessive costs if not properly managed. Based on output from the machine-learning models, actions associated with the high risk change orders may be performed to mitigate the risks and/or costs.

By way of introduction, aspects discussed herein may relate to systems, methods, and techniques for detecting the level of risk and/or significance associated with a change order. Further, the system may train a machine-learning model using different subsets of a dataset corresponding to historical change orders. The system may process change orders that have been received. For example, the change order may be parsed using natural language processing techniques. After the change order has been parsed a level of risk and/or level of significance associated with the change order may be determined. The machine-learning model may then determine actions to perform based on the level of risk and/or level of significance associated with the change order. For example, the machine-learning model may determine that no action needs to be taken at the present time or may determine appropriate actions to perform based on the determined level of risk and/or significance.

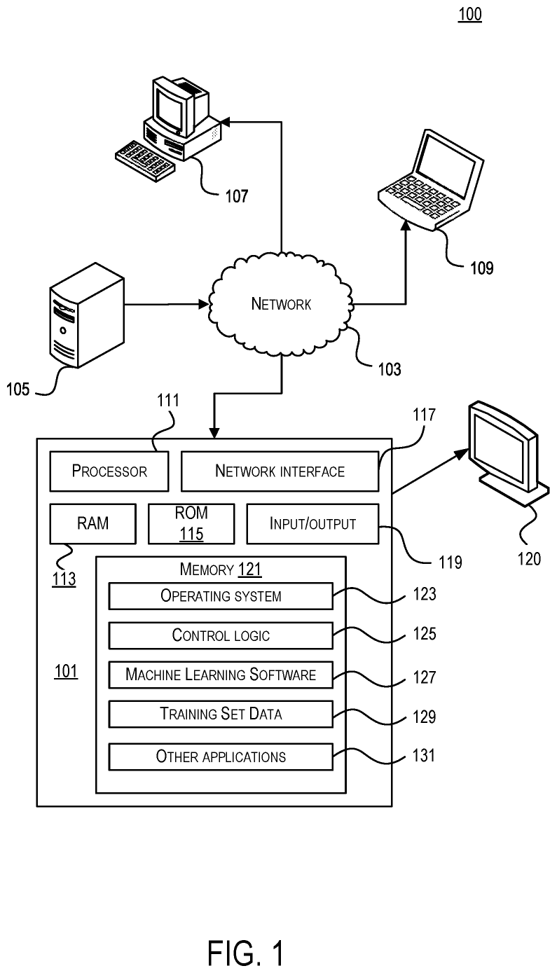

Before discussing these concepts in greater detail, however, several examples of a computing device that may be used in implementing and/or otherwise providing various aspects of the disclosure will first be discussed with respect to FIG. 1.

FIG. 1 illustrates an example of a computing system 100 that may be used to implement one or more illustrative aspects discussed herein. For example, computing system 100 may, in some instances, implement one or more aspects of the disclosure by reading and/or executing instructions and performing one or more actions based on the instructions. In some instances, computing system 100 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing system 100 may, in some instances, operate in a standalone environment. In others, computing system 100 may operate in a networked environment. As shown in FIG. 1, various computing devices including computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Computing devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, stylus, touch screen, camera, microphone, display device, audio output device including a loudspeaker, printer, etc.), and memory 121. Processor 111 may include one or more computer processing units (CPUs), graphical processing units (GPUs), and/or other processing units such as a processor adapted to perform computations associated with machine learning. Input/output interfaces 119 may include a variety of interface units and drives for reading, writing, displaying, and/or printing data or files. Input/output interfaces 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, (e.g., training set data including historical change orders) and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Computing devices 105, 107, 109 may have similar or different architecture as described with respect to computing device 101. Those of skill in the art will appreciate that the functionality of computing device 101 (or computing device 105, computing device 107, computing device 109) as described herein may be spread across multiple data processing devices, for example, to distribute processing load across multiple computers, to segregate transactions based on geographic location, user access level, quality of service (QoS), etc. For example, the computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. By way of example, one or more aspects discussed herein may comprise a computing device, comprising: one or more processors; and memory storing instructions that, when executed by the one or more processors, cause the computing device to perform one or more operations discussed herein. By way of further example, one or more aspects discussed herein may comprise a non-transitory machine-readable medium storing instructions that, when executed by one or more processors, cause the one or more processors to perform one or more steps and/or one or more operations discussed herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium (e.g., a non-transitory machine-readable medium) such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to systems, apparatuses, and methods for determining levels of risk and significance associated with change orders.

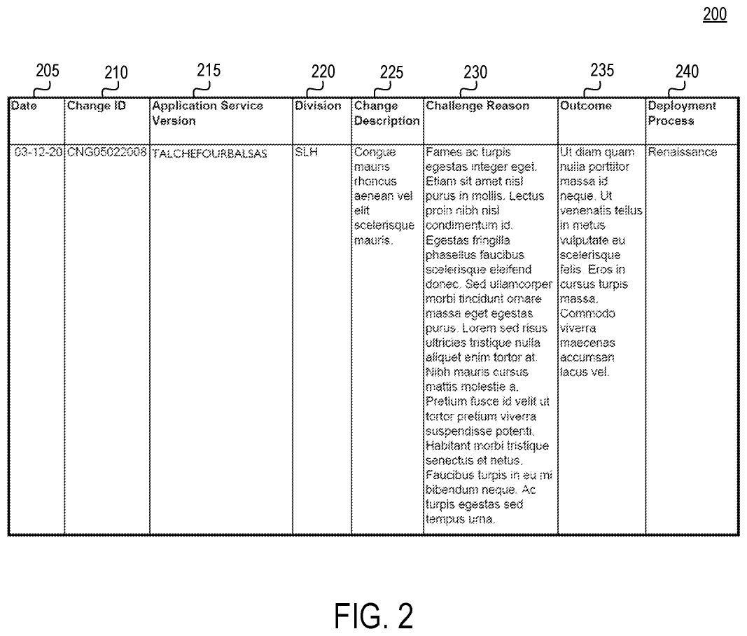

FIG. 2 illustrates an example of a historical change order form according to one or more aspects of the disclosure that may be implemented on the computing system 100 illustrated in FIG. 1, according to a possible embodiment of the invention.

As shown in FIG. 2, the historical change order 200 may include a plurality of fields and a corresponding plurality of values that may comprise information associated with a respective field. The plurality of fields may include a date 205, a change ID 210, an application service version 215, a division 220, a change description 225, a challenge reason 230, an outcome 235, and a deployment 240. The value associated with the date 205 field may indicate the date on which the change order form was submitted and/or the date on which the change order was processed. In some instances, the historical change order 200 may include a time field that indicates the time of day at which the change order form was submitted and/or processed. The date 205 field may be used to track when certain types of change orders occur. Further, the date when certain types of change orders occur may be correlated with other events that are occur within a predetermined time of the change order (e.g., other events that occur within twelve (12) hours or twenty-four (24) hours of the change order date and/or change order time).

The value associated with the change ID 210 field may be used to identify a particular change order. In some instances, the change ID 210 may uniquely identify a change order. The value associated with the application service aversion 215 field may indicate the version of an application associated with the change order. The application service version 215 may be used to track the particular version of an application for which the change order is being made. For example, certain issues may arise when a new version of the application is rolled out and the application service version 215 field may be used to compare the issues that occur with different versions. The value associated with the division 220 field may indicate the division (e.g., an organizational division which may include a department and/or other group) that is associated with the historical change order 200. The value associated with the change description 225 field may include a listing and/or summary of the changes in the historical change order 200. For example, the change description 225 field may indicate that updated code is being deployed for a particular component of an application.

The value associated with the challenge reason 230 field may be used to indicate one or more reasons the historical change order 200 was made. For example, the challenge reason 230 may indicate that certain tasks are overdue, a description of an incident that occurred, an indication of the level of significance of an incident, and/or an indication of the cost of an incident. The value associated with the outcome 235 field may indicate a result associated with the change order including whether an incident was resolved; whether a response to an incident was initiated, ongoing, or completed; and/or details of how an incident was handled including any divisions or individuals involved and/or whether further action is required. The value associated with the deployment 240 field may indicate the name of a system on which the application associated with the change order is deployed.

In some instances, the historical change order 200 may be used as an input to configure and/or train one or more machine-learning models. Further, the historical change order 200 may be tagged and/or labelled with a level of risk and/or a level of significance. The level of risk and/or the level of significance associated with the historical change order 200 may be used when the historical change order 200 is compared to other change orders including change orders that may include similar fields and/or values.

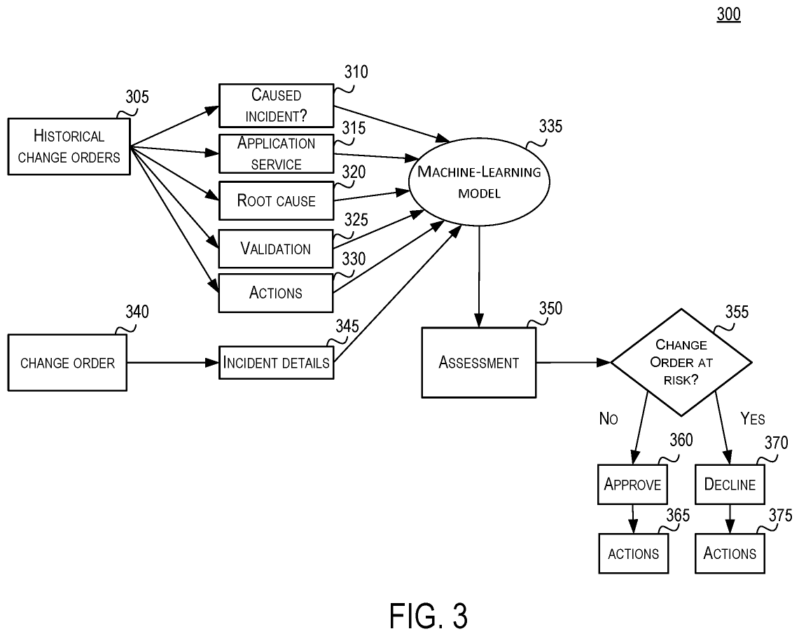

FIG. 3 illustrates an example of training a machine-learning model and detecting change order risk according to one or more aspects of the disclosure that may be implemented on the computing system 100 illustrated in FIG. 1, according to a possible embodiment of the invention.

As shown in FIG. 3, the historical change orders 305 may include a plurality of fields that include corresponding values associated with different aspects of the historical change orders 305. The historical change orders 305 may include change orders that were processed and resolved. Further, the historical change orders 305 may be tagged and/or labelled with a level of risk and/or level of significance that was determined as a result of processing the historical change orders 305. The historical change orders may be formatted in a variety of ways including the format of the historical change order 200 depicted in FIG. 2. The historical change orders may be used as an input to the machine-learning model 335 and any of the fields of the historical change orders 305 may be used as an input to the machine-learning model 335. In this example, the historical change orders 305 may include historical incident details including a caused incident 310 field and corresponding values, an application service version 315 field and corresponding values, a root cause 320 field and corresponding values, a validation 325 field and corresponding values, and an actions 330 field and corresponding values.

The caused incident 310 field of the historical may indicate whether a configuration item associated with the historical change order had previously caused one or more incidents and if so, the details associated with the one or more incidents. For example, the caused incident 310 field may indicate that a configuration item associated with a historical change order has habitually caused incidents following an update One or more events surrounding the update may be used to evaluate the risk of future incidents. The application service version 315 field may indicate the version of an application service that is associated with the historical change order. The application service version 315 may be used to determine whether an application service is up to date and may be used to determine known risks associated with particular versions of the application service. The root cause 320 field may indicate a root cause that is associated with the incident. For example, the root cause may indicate that a system on which a configuration item relies on had failed, which led to the issues with the configuration item. The validation 325 field may indicate whether an issue associated with an incident is a validation issue. For example, validation issues may include a configuration item not being properly validated before being put into service. The actions 330 field may indicate any actions that were performed as a result of a historical change order. For example, the actions may include any actions that were taken to address an incident including replacing a configuration item, upgrading a configuration item, and/or rolling back a configuration item.

The change order 340 may include a change order for an incident that has not been processed or resolved. The change order 340 may include incident details 345 which may include any of the fields of the historical incident details of the historical change orders 305 or any other change order described herein.

The machine-learning model 335 may be configured and/or trained to determine a level of risk and/or a level of significance based on receipt of input including the historical change orders 305. Further, the machine-learning model 335 which has been configured and/or trained may receive input comprising the incident details 345, perform operations on the incident details 345, and generate output including the assessment 350. The machine-learning model 335 may be configured and/or trained in accordance with one or more aspects described herein. The assessment 350 may include a level of risk and/or a level of significance associated with the historical change orders 305. Based on the assessment 350, the system 300 may at step 355 determine whether the change order is at risk. The determination of whether the change order is at risk may be based in part on whether the level of risk determined in the assessment 350 is greater than or equal to a risk threshold. If the level of risk is greater than or equal to the risk threshold, the system may determine that the change order is not at risk and may approve the change order at the step 360 after which one or more actions (e.g., sending a notification that the change order 340 is not at risk to one or more managers associated with the change order) may be performed at the step 365. If the system determines that the change order is at risk, the change order may be declined at step 370 following which or more actions associated with declining the change order 340 may be performed. For example, the change order 340 may be sent to a review committee for further review.

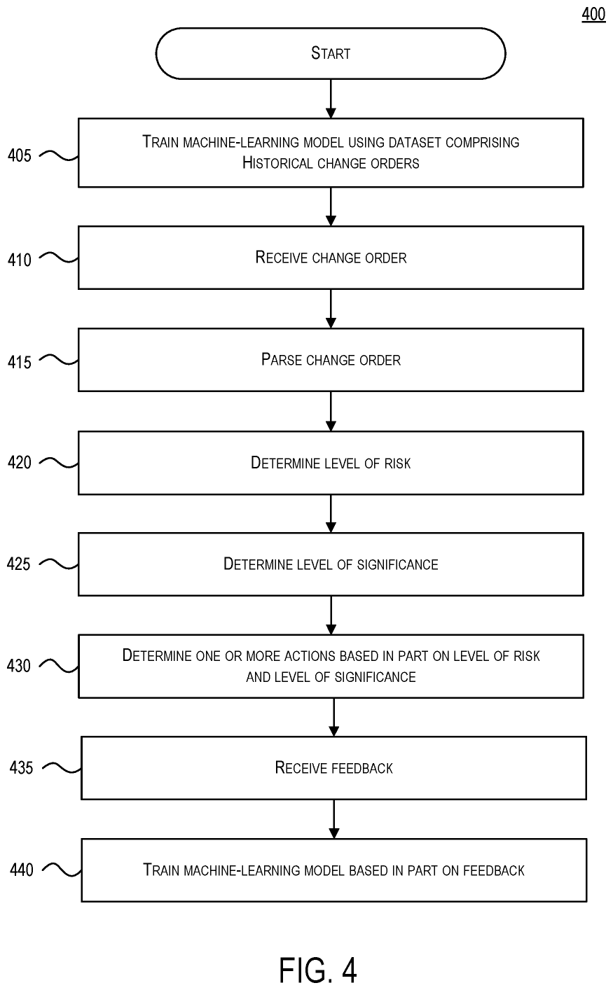

FIG. 4 illustrates an example flow chart for a method of detecting change order risk and significance according to one or more aspects of the disclosure. Method 400 may be implemented by a suitable computing system, as described further herein. For example, method 400 may be implemented by any suitable computing environment by a computing device and/or combination of computing devices, such as computing devices 101, 105, 107, and 109 of FIG. 1. Method 400 may be implemented in suitable program instructions, such as in machine learning software 127, and may operate on a suitable training set, such as training set data 129.

At step 405, the system may configure and/or train one or more machine-learning models. The one or more machine-learning models may be configured and/or trained to determine a level of risk associated with a change order for a configuration item. For example, the one or more machine-learning models may be configured and/or trained to receive an input comprising a change order, perform operations on the input, and generate an output including a level of risk for the change order. The level of risk may be associated with the probability or likelihood of the occurrence of an incident (e.g., an incident that causes an adverse outcome) associated with the change order. A greater level of risk may be associated with a greater probability or likelihood that one or more incidents (e.g., adverse incidents) associated with the change order may occur. The one or more incidents associated with the change order may comprise a configuration item failing (e.g., system failure or component failure), a configuration item not completing one or more tasks before a particular time (e.g., a missed deadline), a configuration item causing one or more incidents in one or more other configuration items, and/or a configuration item not being updated before a particular time or in accordance with an update schedule.

The level of risk may comprise one or more values that indicate the risk associated with the change order. For example, the level of risk may be associated with a score (e.g., a numeric value) in which the score is positively correlated with the level of risk (e.g., a low score corresponds to a low level of risk and a high score corresponds to a high level of risk). A higher score may indicate a higher probability and/or likelihood that an incident may occur.

In some instances, the one or more machine-learning models may be configured and/or trained to determine a level of significance associated with a change order for a configuration item. For example, the one or more machine-learning models may be configured and/or trained to receive an input comprising a change order, perform operations on the input, and generate an output including a level of significance associated with the change order. The level of significance may be associated with the magnitude of the adverse effects that may result from the occurrence of an incident (e.g., an incident that causes an adverse outcome) associated with the change order. A greater level of significance may be associated with a greater level of harm and/or cost that may result if an incident occurs. The level of significance associated with the change order may be associated with the extent to which a configuration item fails (e.g., a partial failure of a system or component may be less severe than a complete failure of a component), the cost associated with an incident, the number of other configuration items that are adversely affected by the incident, the importance of the configuration item affected by the incident, whether the incident affects a configuration item that is redundant, and/or the duration for which a configuration item may be inactive, malfunctioning, or unavailable (e.g., the level of significance of an incident may be positively correlated with the duration that a configuration item is likely to be unavailable). The level of significance may comprise one or more values that indicate the magnitude of the significance of an incident. For example, the level of significance may be associated with a significance value in which the value is positively correlated with the level of significance (e.g., a high significance value corresponds to a high level of significance).

A configuration item may include anything (e.g., a system and/or a component) manageable within a configuration management system. A configuration management system may include a system that is under some form of change control in which changes to the system (e.g., changes to the entire system or part of the system) are controlled. Management and/or control of the system may be performed by a human manager (e.g., a person with authority to review, decline, and/or accept changes to the system) and/or any of the systems described herein.

In some embodiments, the lifecycle of a configuration item may be indeterminate. For example, a configuration item may include an ongoing process that does not have a definite resolution time (e.g., a crucial software component that is continuously updated but not replaced). In some instances, the lifecycle of a configuration item may be determinate. For example, a configuration item may include a task that is part of a process in which the task is initiated, performed, and concluded.

Training the one or more machine-learning models may include the use of a dataset comprising historical change orders. The historical change orders may comprise previously processed change orders and/or change orders that have been manually generated for the purpose of training the one or more machine-learning models. The system may train the one or more machine-learning models by inputting one or more subsets of dataset comprising the historical change orders into the machine-learning model, which may process the dataset and generate an output comprising a level of risk associated with the change order and/or a level of significance associated with the change order. Further, configuring and/or training the one or more machine-learning models may be based in part on use of one or more supervised machine-learning techniques and/or unsupervised learning machine-learning techniques.

The one or more supervised learning techniques may include the use of training dataset comprising historical change orders that have been labelled and/or tagged. The labels/tags associated with the historical change orders may include change orders and respective levels of risk and/or level of significance associated with the change orders. The training dataset may be provided to one or more machine-learning models that process the training dataset and generate output including a predicted level of risk and/or predicted level of significance. The output of the one or more machine-learning models may be compared to ground truth results based on the labelled and/or tagged historical change orders. Based on the differences between the output of the one or more machine-learning models and the ground truth results the system may adjust the weighting and/or composition (e.g., the parameters that are included in the one or more machine-learning models) of parameters of the one or more machine-learning models based on the use of a loss function that generates a loss associated with the accuracy of detecting a level of risk and/or level of significance associated with a change order. The parameters that make a greater contribution to minimizing the loss that is output by the loss function may be more heavily weighted than the parameters that make less of a contribution to minimizing the loss that is output by the loss function. The one or more machine-learning models may be trained over a plurality of iterations. Further, the training dataset may be updated over time and the one or more machine-learning models may be trained/retrained using the updated training dataset.

The one or more machine-learning models may include recurrent neural network models (RNN), convolutional neural network models (CNN), support-vector networks, induction of decision trees, random forests, bootstrap aggregating, k-means clustering, k-nearest neighbors (k-NN), k-medoids clustering, regression, Bayesian networks, relevance vector machine (RVM), support vector machines (SVM), generative adversarial networks (GAN), and the like. The present disclosure may utilize other statistical analysis methods, which may include multivariate or univariate statistical analysis.

Selected data (e.g., the dataset comprising historical change orders) may be transferred into a memory device within a processor or computing device. Machine learning software located within the processor or computing device may be configured to receive the selected data. Machine learning software may be previously trained, run a training program immediately subsequent to data profiling, or designed for active learning alongside the data profiling step. Training may entail one or more training dataset batches, one or more epochs, hyperparameter tuning, optimization models, and the like.

The training dataset may include statistics that are based on information comprising historical change orders and/or incident details associated with the historical change orders. The statistics included in the training dataset may include a mean, mode, median, maximum, minimum, minimum, and/or standard deviation that are associated with various incident details and/or outcomes of the historical change orders of the training dataset. For example, the training dataset may include a mean time between updates for a particular type of change order based on the actual time for change orders of that particular type over the past year. By way of further example, the training dataset may include levels of risk and/or level of significance of historical change orders that were determined over the course of some time period (e.g., a year). The training dataset may include information that is structured in different file types, including textual data (e.g., HyperText Markup Language (HTML), extensible Markup Language (XML), plain text, or the like); tabular data (such as comma-separated values (CSV), tab-delimited file (TAB), or the like); or another field type.

In some instances, the system may train the one or more machine-learning models by performing, using the one or more machine-learning models, a trend analysis of the historical change orders. The trend analysis of the historical change orders may be based in part on an analysis of the types of outcomes that result from certain types of incidents described in the historical change orders. The outcomes of historical change orders may be used to predict the outcome of new change orders.

Furthermore the historical change orders may correspond to and/or be associated with one or more organization/departments. For example, the historical change orders may indicate that a particular organization/department has a higher than average historical level of risk associated with change orders that originate from that organization/department. The particular organization/department indicated in a change order may be a factor that is used when determining the level of risk and/or level of significance of a particular change order.

The dataset comprising historical change orders may include information associated with the level of risk and/or level of significance of change orders that have caused incidents in the past. For example, the historical change orders may include a type of incident, total number of incidents, and/or rate of incidents from a particular organization/department within a specified time period (e.g., the number of incidents associated with delayed updates from the particular department in the past year).

The system may use hyperparameter tuning to optimize a set of hyperparameters and improve the performance of the one or more machine-learning models. For example, based at least in part on use of a loss function associated with the accuracy of the level or risk and/or level of significance of an incident, the system may adjust one or more hyperparameters associated with minimization of the loss (e.g., the hyperparameters that result in a lower loss that corresponds to more accurate determination of the level of risk and/or level of significance of a change order). Improving the accuracy of detecting the level of risk and/or level of significance associated with a change order may include increasing a true positive rate (e.g., determining that a level of risk associated with a change order is high when an incident occurred) and/or decreasing a false positive rate (e.g., determining that the level of risk is low when no incident occurred).

The system may use any of the models, algorithms, methods, or the like that are described herein to configure and/or train one or more machine-learning models to determine a level of risk and/or level of significance associated with a change order for a configuration item.

At step 410, the system may automatically receive, access, obtain, and/or retrieve a change order. The change order may comprise incident details. The incident details may be associated with an incident. For example, the incident details may indicate a date of an incident, a date of the change order, an application service change description, a challenge reason, and/or any of the incident details described in the change order forms described herein including the historical change order 200 that is depicted in FIG. 2.

The change order may comprise information associated with the type of change order that is being requested, the reason for the change order, and/or the way in which the change order may be implemented. For example, the change order may indicate that the current version of an application is being rolled back to a previous version of the application as a result of issues that arose when the current version was implemented. By way of further example, the change order may indicate instructions and/or steps that should be followed to implement the changes indicated in the change order. In some instances, the change order may comprise the name of the department that originated the change order, the type of change order, and/or the location (e.g., the geographic location) from which the change order originated.

In some instances, the change order may comprise a change order timeline. The change order timeline may comprise any deadlines and/or milestones that are associated with the change order. For example, the change order timeline information may include a release date for a configuration item and/or milestones for certain tasks to be completed by a particular system.

Furthermore, the incident details may correspond to an amount of time that the change order has not been processed. For example, the incident details may indicate an amount of time since a change order was submitted to a manager and/or reviewing committee without being processed. Further, the incident details may include a status of a change order which may include one or more actions that have been performed on the change order. For example, the status of the change order may indicate how many of the steps to process the change order have been completed. Further, the status of the change order may indicate the relative position of a change order in a change order queue. For example, the status of the change order may indicate that a change order is near the top of a queue and may include an estimated time before the change order is processed based on the rate of processing of other change orders in the change order queue.

The change order may comprise one or more fields (e.g., the fields of the historical change order 200 depicted in FIG. 2) associated with one or more incident details. For example, a field of a change order may indicate a change description that describes a change that is planned for a configuration item. Further, the one or more fields of the change order may be associated with one or more values (e.g., the values of the historical change order 200 depicted in FIG. 2). For example, the one or more values for a field indicating a change description may include a description of the particular configuration item that the change is planned for and the specific types of changes that may be implemented in the configuration item.

At step 415, the system may automatically parse the change order. Parsing the change order may comprise using the one or more machine-learning models and/or one or more rules (e.g., parsing rules that may include grammatical rules and other rules associated with syntactic structure). Further, parsing the change order may comprise determining and/or classifying one or more terms in the incident details and/or the change order. Parsing the change order may include the one or more machine-learning models extracting content (e.g., terms which may include words, phrases, and/or numeric values) from the change order, classifying the terms, and/or performing a syntactic analysis of the content.

In some instances, the one or more machine-learning models may segment the content of a change order and/or incident details into words and/or phrases, classify the words and/or phrases, and determine a syntactic structure of the content in the change order. For example, a change description for a change order may include the content “ROLL BACK TO VERSION 1.2” which may be segmented into five (5) segments including four (4) words and one (1) numeric value. The five (5) segments of the change order may then be classified by the one or more machine-learning models. Classification of the five segments of the change order may include the determination of one or more terms which may comprise one or more key terms in the incident details. In this example, the one or more key terms may include the key term “ROLL BACK” which indicates rolling back a software application to an earlier version, and the key term “VERSION 1.2” which indicates the version of a software application. The system may then determine the syntactic structure of the change order and determine that the description is requesting that the software application should be rolled back to version 1.2.

In some instances, classifying the one or more terms may comprise determining which segments of the segmented change order and/or incident details are key terms and/or which segments of the segmented change order and/or incident details are not key terms. Of the terms that have been determined to be key terms, the one or more machine-learning models may classify the key terms based in part on factors including the context (e.g., other terms that are associated with the key term) within which the key term is used. Any part of the change order (e.g., the application service version, division, change description, and/or challenge reason) may be used as part of the context that is used to determine key terms in another part of the change order. For example, the change description may provide context that is used to parse the challenge reason.

In some instances, the segmentation of the change order and/or determination of the one or more terms and/or one or more key terms may be based on the detection of one or more terms that are part of a term library and/or one or more key terms that are part of a key term library. The term library and/or the key term library may include one or more terms that have been determined (based on configuring and/or training the one or more machine-learning models and/or manual selection) to be significant with respect to determining a level of risk and/or level of significance of the change order. The one or more key terms may include terms that have a greater impact with respect to determining the level of risk and/or the level of significance associated with a change order. Further, the one or more key terms may include terms that, based on configuring and/or training the one or more machine-learning models, have an increased probability of being determinative of the level of risk and/or the level of significance of a change order. For example, terms including “EMERGENCY,” “NOW,” and “IMMEDIATELY” may be included as part of one or more key terms. Key terms may be associated with different levels of risk and/or levels of significance based on context. For example, the key term “EMERGENCY” as part of the phrase “THIS IS NOT AN EMERGENCY AND CAN BE ADDRESSED LATER” may be associated with a lower level of risk and/or level of significance than when the key term “EMERGENCY” is part of the phrase “THIS IS AN EMERGENCY THAT NEEDS TO BE ADDRESSED IMMEDIATELY.”

In some instances, the system may use one or more rules to parse the content order. For example, the one or more rules may include rules associated with negation (e.g., the word “NOT” before a term), rules associated with conditional statements, rules associated with the placement of words within a change order (e.g., words at the beginning or end of a change order description), and/or rules associated with the spelling of terms in the change order. For example, the change order may include “DO NOT ROLL BACK UNLESS” which may be parsed as a conditional statement in which an application should not be rolled back unless some condition is met. By way of further example, the change order may include “UPDATE ON STURDAY” which may be determined to be a typographical error in which the term “STURDAY” which is not an actual word is interpreted as “SATURDAY” meaning a day of the week.

In some instances, parsing the change order may include applying one or more key term criteria to one or more terms of the change order. In some instances, the one or more key term criteria may include a term frequency threshold in which a term that is included in the change order may be determined to be a key term if the term occurs a certain number of times. Some terms may be determined to be a key term if the term occurs once within a change order. Other terms may be determined to be a key term if the term occurs at a rate that is equal to or greater than the term frequency threshold.

In some instances, the one or more key term criteria may comprise the one or more terms matching one or more incident key terms. The one or more incident key terms may comprise terms that have been previously determined to be associated with an incident. The system may then determine that any of the one or more terms of the change order that match any of the one or more incident key terms is a key term. For example, the terms “high priority,” “urgent matter,” and/or “update needed immediately” may be determined to be incident key terms that are associated with an incident and the system may determine that the terms are key terms if those terms are detected in the change order.

Further, parsing the change order may include determining the one or more key terms based in part on the one or more terms that satisfy the one or more key term criteria. For example, the one or more key term criteria may be determined to have been satisfied if a term has occurred at a rate that is greater than the term frequency threshold. For example, if the term comprising the name of a manager occurs at a rate that is greater than or equal to the term frequency threshold, the name of the manager may be determined to be a key term. By way of further example, the one or more key term criteria may be determined to have been satisfied if an incident key term like “EMERGENCY” is detected.

In some instances, the system (e.g., the one or more machine-learning models used to parse the change order) may use one or more natural language processing techniques to parse the historical change orders and/or the change order. For example, the system may use a convolutional neural network that was trained using historical change orders to parse new change orders. Parsing new change orders may include determining the structure and semantic content of the new change orders.

At step 420, the system may determine and/or generate a level of risk associated with the change order. The change order may be a parsed change order in which one or more terms (e.g., one or more key terms) were determined. The one or more terms that were determined may determine the way the level of risk is determined. For example, the one or more portions of the change order that one or more terms may be accorded greater weight Determining and/or generating the level of risk associated with the change order may be based in part on the change order and/or one or more machine-learning models. The level of risk may be a predicted and/or estimated level of risk that is associated with the change order.

Generating and/or determining the level of risk may comprise inputting the incident details and/or the change order into the machine-learning model. The one or more machine-learning models may be configured and/or trained to determine and/or generate a level of risk based in part on an input comprising the change order. For example, the one or more machine-learning models may analyze the change order and use incident details comprising a challenge reason (e.g., the challenge reason 230 depicted in FIG. 2) as an input. Based in part on training the one or more machine-learning models based in part on the use of a large number of historical change orders comprising challenge reasons and corresponding outcomes, the one or more machine-learning models may generate an output including a level of risk.

In some instances, the level of risk associated with a change order may be inversely correlated with the time remaining until a deadline and/or milestone associated with change order. For example, the level of risk associated with a change order in which a task is scheduled for completion in one (1) day may be greater than the level of risk associated with a change order in which the same task is scheduled for completion in one (1) week.

At step 425, the system may determine and/or generate a level of significance associated with the change order (e.g., a level of significance associated with an incident and/or potential incident indicated in the change order). Determination and/or generation of the level of significance associated with the change order may comprise the use of one or more machine-learning models.

Generating and/or determining the level of significance may comprise inputting the change order into one or more machine-learning models. The one or more machine-learning models may be configured and/or trained to determine and/or generate a level of significance associated with the change order (e.g., the significance of an incident or potential incident indicated in the change order) based in part on an input comprising the change order. The one or more machine-learning models may have been configured and/or trained using historical change orders in which change orders and corresponding levels of significance were determined. By way of example, the one or more machine-learning models may analyze the change order and use a change description (e.g., the change description 225 depicted in FIG. 2) as an input. The one or more machine-learning models may then process the change order and determine a level of significance based in part on the change description.

In some instances, the level of significance associated with the change order may be based in part on the significance of a component and/or system indicated in the change order. The significance of a component and/or system indicated in the change order may be based in part on the extent to which the component is replaceable (e.g., an easily replaceable component is less significant than a difficult to replace component), whether the component is redundant (e.g., a redundant component is less significant than a non-redundant component), the cost associated with replacing the component (e.g., a component that is inexpensive to replace is less significant than a component that is expensive to replace), and/or the costs that may accrue from the component malfunctioning (e.g., the significance of a component may be positively correlated with the costs that accrue when the component malfunctions). The level of significance associated with the change order may be positively correlated with the significance.

In some instances, the level of significance of the incident may correspond to and/or be based in part on the one or more terms (e.g., one or more key terms). For example, an incident in which the incident details describe a system as “mission critical” and that the issue needs to be resolved “immediately” may have a high level of significance. By way of further example, an incident in which the incident details indicate that a new feature would be “nice to have in the next release” may have a low level of significance.

Further, the one or more terms (e.g., one or more key terms) may be associated with one or more significance values. For example, each of the one or more terms may include a range of values that may be associated with significance and/or modify the significance of other adjacent terms. For example, the terms “serious problem” may have a significance value that is high, the combination of the terms “not a serious problem” may have a significance value that is low, and the combination of the terms “very serious problem” may have a significance value that is higher than just the terms “serious problem.”

In some instances, the level of significance of the incident may be positively correlated with a frequency of the occurrence of the one or more terms and/or an aggregate of the one or more significance values of the one or more terms. For example, a greater occurrence of combinations of terms that are indicative of high significance may correspond to a higher level of significance.

In some instances, the level of significance may be associated with a number of users impacted by the change order and/or an estimated cost (e.g., a cost due to a configuration item being unavailable, a cost in terms of expenses (e.g., dollars to update a configuration item), and/or a cost in terms of time) associated with the change order. For example, a change order that impacts ten-thousand (10,000) users (e.g., a change order to update software used by every user in a company) may be associated with a higher level of significance than a change order that is associated with a configuration item that is used by a dozen users in a single department. By way of further example, the level of significance for a change order that is associated with changes to a configuration item that are estimated to cost five-thousand dollars (S5,000.00) would be greater than the level of significance for a change order that is associated with changes to a configuration that are estimated to cost five-thousand dollars (S5,000.00).

At 430, the system may determine, generate, and/or perform one or more actions to address the incident. Determination, generation, and/or performance of the one or more actions may be based in part on the level of risk and/or the level of significance associated with the change order. Further, determination of the one or more actions may be based in part on the use of one or more machine-learning models. The determination of the one or more actions to address the incident may be based in part on use of one or more machine-learning models. For example, the change order may be provided as an input to one or more machine-learning models that have been configured and/or trained to generate output comprising one or more actions (e.g., actions to address and/or remediate the issue).

In some instances, a combination of the level of risk and/or the level of significance may be compared to one or more thresholds that are used to determine whether any action is taken. If the combination of the level of risk and/or the level of significance of the incident are greater than or equal to one or more thresholds, a first set of actions may be taken. For example, the first set of actions may comprise initiating an update to a configuration item that was scheduled to be updated. If the combination of the level of risk and/or the level of significance of the incident are less than the one or more thresholds, a second set of actions may be taken to address the incident. For example, the second set of actions may comprise the system monitoring the configuration item and sending a notification to a manager if the issue with the configuration item is not addressed within a predetermined time period.

In some instances, the one or more actions may comprise generating one or more notifications. The one or more notifications may comprise one or more indications identifying the change order and indicating the level of risk and/or level of significance associated with the change order. For example, the one or more actions may include sending a notification indicating that the level of risk exceeds a risk threshold and/or that the level of significance exceeds a significance threshold to a manager that is authorized to address the incident. In some instances, the notification may comprise an indication of the name of the department that is associated with the change order. For example, the notification may include an indication that an incident should be handled by a particular department that is responsible for that type of incident.

At 435, the system may access and/or receive feedback associated with the one or more actions. The feedback may be received from one or more users of the system. Further, the feedback may be based on an analysis of the outcome associated with a change order that may be performed using one or more machine-learning models that are configured and/or trained to determine outcomes of incidents. For example, one or more machine-learning models may be trained to determine the costs associated with resolution of an incident and/or to determine the time it took to resolve the incident.

The feedback may comprise an indication of which of the one or more actions were implemented and/or results associated with the one or more actions. The feedback may include whether an incident was resolved, a rating of the costs associated with resolving an incident associated with a change order, the time it takes to resolve an incident, and/or any other configuration items that were affected by the one or more actions taken with respect to the change order. For example, the feedback may include an indication of whether the one or more actions that were taken to resolve an incident actually resolved the incident.

At step 440, the system may train the one or more machine-learning models based at least in part on the feedback. For example, the feedback received with respect to the change order may indicate that certain aspects of the change order (e.g., timeliness) should be weighted more heavily for certain types of change orders. As a result, the weighting of the plurality of parameters of the one or more machine-learning models can be accordingly adjusted to reflect the feedback that was received. For example, the feedback may indicate that the one or more actions would have been more effective (e.g., resulted in less system down time) if the one or more actions had been performed within twelve (12) hours instead of being performed after twenty-four (24) hours.

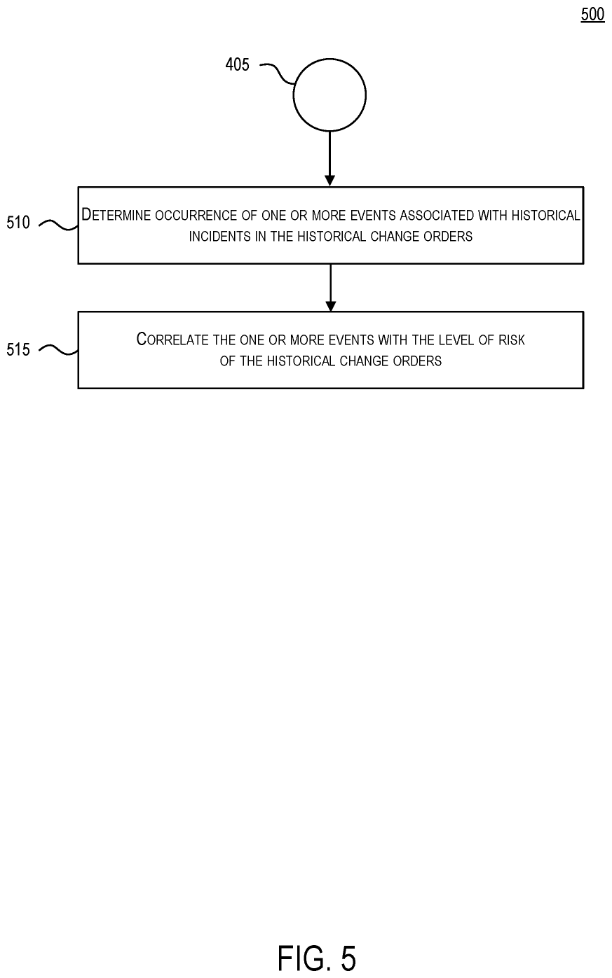

FIG. 5 illustrates an example flow chart for a method of training one or more machine-learning models by performing trend analysis in accordance with one or more aspects described herein. Method 500 may be implemented by a suitable computing system, as described further herein. For example, method 500 may be implemented by any suitable computing environment by a computing device and/or combination of computing devices, such as computing devices 101, 105, 107, and 109 of FIG. 1. Method 500 may be implemented in suitable program instructions, such as in machine learning software 127, and may operate on a suitable training set, such as training set data 129. Furthermore, one or more steps and/or one or more portions of method 500 may be incorporated into method 400. In some instances, one or more steps of method 500 may be used as part of training one or more machine-learning models as described at step 405 of method 400.

At step 510, the system may determine one or more occurrences of one or more events associated with historical incidents in the historical change orders. In some instances, the one or more machine-learning models may determine one or more events that occurred prior to a historical incident. Further, the system may access a historical change order and determine one or more events related to a historical incident associated with the change order that occurred within a predetermined time period (e.g., one (1) month) prior to the historical incident. For example, if a particular configuration item has missed a scheduled update, the system may determine the one or more tasks that were supposed to occur before the update (e.g., the one or more tasks may be listed in an update protocol) and may determine the tasks that were completed and the tasks that were not completed. Further, the system may determine the timing of tasks that were completed in order to determine the tasks that were not completed in time. In some instances, determining the occurrence of one or more events associated with historical incidents in the historical change orders may be performed as part of training the one or more machine-learning models.

At step 515, the system may the correlate the one or more events with the level of risk of the historical change orders. In some instances, the one or more machine-learning models may determine relationships between the one or more events and the occurrence of the historical incident. For example, the system may determine one or more events that occurred before a historical incident associated with a high level of risk and compare the one or more events to historical incidents of the same type that are associated with a low level of risk. The system may then determine that the one or more events associated with high level of risk historical incident that did not occur in the low level of risk historical incident are correlated with a higher level of risk. In some instances, correlating the one or more events with the level of risk of the historical change orders may be performed as part of training the one or more machine-learning models.

In some instances, the system may determine the frequency with which one or more events occur within a predetermined time period of a high level of risk historical incident. The system may then determine that one or more events that occur within the predetermined time period of the high level of risk historical incident at greater than an event frequency threshold may be determined to be associated with the high level of risk historical incident.

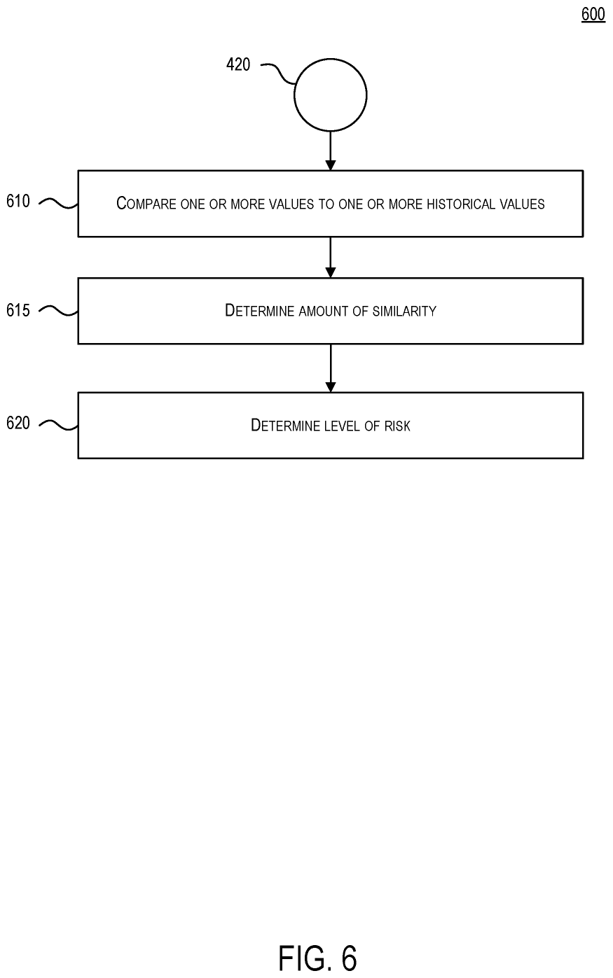

FIG. 6 illustrates an example flow chart for a method of detecting change order risk and cost according to one or more aspects of the disclosure. Method 600 may be implemented by a suitable computing system, as described further herein. For example, method 600 may be implemented by any suitable computing environment by a computing device and/or combination of computing devices, such as computing devices 101, 105, 107, and 109 of FIG. 1. Method 600 may be implemented in suitable program instructions, such as in machine learning software 127, and may operate on a suitable training set, such as training set data 129. Furthermore, one or more steps and/or one or more portions of method 600 may be incorporated into method 400. In some instances, one or more steps of method 600 may be used as part of determining a level of risk as described at step 420 of method 400 and/or as part of determining a level of significance as described at step 425 of method 400.

At step 610, the system may compare, using the one or more machine-learning models, one or more values associated with one or more fields of the change order to one or more historical values of one or more corresponding historical fields associated with historical change orders. For example, the system may compare the change order to similar types of historical change orders based on matching the values in the challenge reason field and/or change description field of the change order to historical change orders that have similar values. In this way, a change order may be matched with historical change orders that have similar configuration items for which similar types of changes are being requested. In some instances, historical change orders that are not of the same type as the change order may be excluded from the comparison.

At step 615, the system may determine an amount of similarity between the change order and each of the historical change orders. The amount of similarity may be determined based on the comparison of the one or more values of the change order to the one or more historical values of the historical change orders. For example, the system may use one or more machine-learning models that are configured and/or trained to determine the similarity between the one or more values of the change order and the one or more values of the historical change orders. The one or more machine-learning models may be configured and/or trained to segment and then classify the one or more values and the one or more historical values. The one or more machine-learning models may then determine the proportion of the one or more classified historical values in each historical change order that match the one or more classified values of the change order. The amount of similarity may be based in part on the proportion of the one or more classified historical values that match the one or more classified values. In some instances, one or more key words in the change order may be weighted more heavily and the presence of the one or more key words in the historical change orders may be associated with a greater amount of similarity.

At step 620, the system may determine the level of risk and/or the level of significance based in part on an extent to which the change order is similar to the historical change order. Further, the historical change orders may be tagged with a respective level of risk and/or level of significance. The system may then determine that the level of risk and/or the level of significance for the change order is based in part on the extent to which the level of risk and/or the level of significance of the historical change order is similar to the change order. For example, if a change order is very similar (e.g., a change request for the same type of configuration item that is made on a weekly basis) to a historical change order that has a level of risk of twenty (20) on a scale of one (1) to one-hundred (100) with one (1) being the lowest level of risk and one-hundred (100) being the highest level of risk

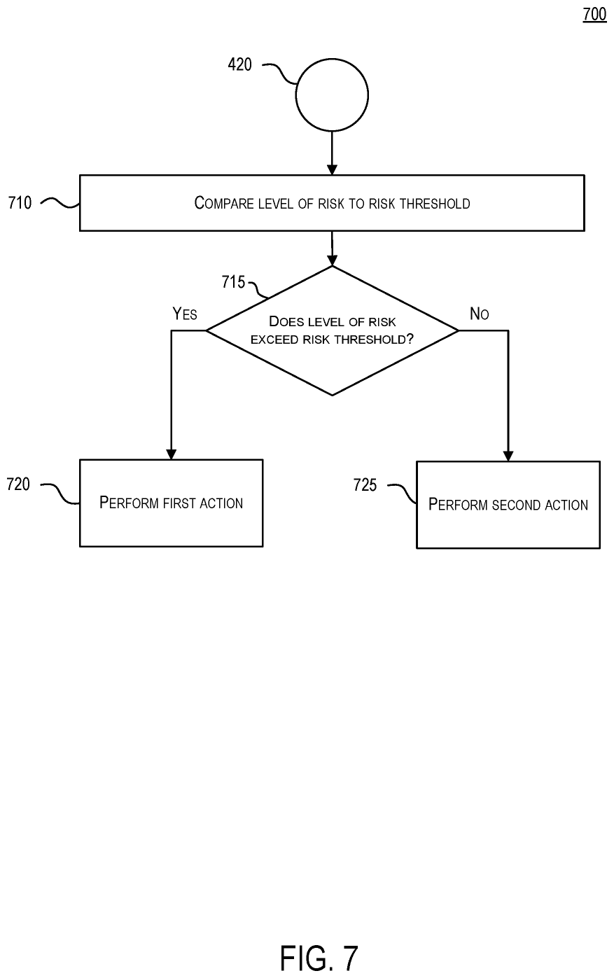

FIG. 7 illustrates an example flow chart for a method of determining a level of risk and performing actions according to one or more aspects of the disclosure. Method 700 may be implemented by a suitable computing system, as described further herein. For example, method 700 may be implemented by any suitable computing environment by a computing device and/or combination of computing devices, such as computing devices 101, 105, 107, and 109 of FIG. 1. Method 700 may be implemented in suitable program instructions, such as in machine learning software 127, and may operate on a suitable training set, such as training set data 129. Furthermore, one or more steps and/or one or more portions of method 700 may be incorporated into method 400. In some instances, one or more steps of method 600 may be used as part of determining a level of risk as described at step 420 of method 400 and/or as part of determining a level of significance as described at step 425 of method 400.

At step 710, the system may automatically compare the level of risk to a risk threshold. In some instances, the system may automatically compare the level of significance to a significance threshold. The comparison of the level of risk to the risk threshold and/or the level of significance to the significance threshold may comprise a determination of the extent to which the level of risk matches and/or is similar to the risk threshold and/or the extent to which the level of significance matches and/or is similar to the significance threshold. The resulting comparison may produce an output indicating whether the level of risk is greater than the risk threshold, equal to the risk threshold, or less than the risk threshold. The resulting comparison of the level of significance to the significance threshold may produce an output indicating whether the level of significance is greater than the significance threshold, equal to the significance threshold, or less than the significance threshold.

At step 715, after comparing the level of risk to the risk threshold and/or comparing the level of significance to the significance threshold at step 710, the system may determine whether the level of risk is greater than or equal to the risk threshold and/or whether the level of significance is greater than the significance threshold. In response to the level of risk being greater than or equal to the risk threshold and/or the level of significance being greater than or equal to the significance threshold, the system may perform step 720. In response to the level of risk being less than the risk threshold and/or the level of significance being less than the significance threshold, the system may perform step 725.

At step 720, the system may automatically determine that a first action of the one or more actions may be performed if the level of risk is greater than or equal to the risk threshold and/or if the level of significance is greater than or equal to the significance threshold. For example, if the level of risk is greater than a risk threshold, the system may determine that the change order should be reviewed by a management analysis group that may evaluate the change order to determine further action to take with respect to the change order. In some instances, the system may determine that the first action comprises sending the change order to one or more computing devices associated with a change management analysis group. For example, the system may determine that the level of risk is high enough (e.g., the level of risk exceeds the risk threshold) that the change order should be evaluated by a manager with authority to evaluate the change order and/or implement any changes indicated in the change order.

At step 725, the system may automatically determine that a second action of the one or more actions may be performed if the level of risk is less than the risk threshold and/or if the level of significance is less than a significance threshold. For example, if the level of risk is less than a risk threshold, the system may determine that the change order is of a relatively low level of risk and that one or more actions to process the change order may be determined and/or generated by one or more machine-learning models (e.g., the one or more actions described in step 430 of the method 400 depicted in FIG. 4).

In some instances, the system may determine that the second action comprises determining by the one or more machine-learning models, implementation details of the second action to resolve the incident. The one or more machine-learning models may be configured and/or trained to use the change order as an input and generate an output comprising implementation details (e.g., a set of steps and/or instructions) to resolve an incident indicated in the change order. For example, the change order may include a request to replace a storage system and the system may generate a request to replace the storage system that is sent to the appropriate department with authority to replace the storage system. In some instances, the implementation details may be implemented by the system (e.g., the system may perform an action to resolve an incident) and/or provided to another entity (e.g., a management analysis group) for implementation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed using any manner of device, system, and/or apparatus including the computing devices, computing systems, and/or computing apparatuses that are described herein.

What is claimed is:

1. A method comprising:
training, using a dataset comprising historical change orders, one or more machine-learning models to determine a level of risk associated with a change order for a configuration item;
receiving, by a computing device, a change order comprising incident details associated with an incident;
parsing, by the computing device, using the one or more machine-learning models, the change order, wherein the parsing comprises classifying one or more terms in the incident details;
determining, by the computing device, based in part on the change order and the one or more machine-learning models, the level of risk associated with the change order; and
determining, by the computing device, based in part on the level of risk associated with the change order, one or more actions to address the incident.

2. The method of claim 1, wherein the change order comprises one or more fields and one or more values associated with the change order, and wherein the determining, by the computing device, based in part on the change order and the one or more machine-learning models, the level of risk associated with the change order comprises:
comparing, by the computing device, using the one or more machine-learning models, the one or more values to one or more historical values of one or more corresponding historical fields associated with the historical change orders;
determining, by the computing device, based on the comparison of the one or more values to the one or more historical values, an amount of similarity between the change order and the historical change orders; and
determining, by the computing device, the level of risk based in part on an extent to which the one or more values of the change order are similar to the one or more historical values of the historical change orders.

3. The method of claim 1, wherein the one or more machine-learning models use one or more natural language processing techniques to parse the historical change orders or the change order.

4. The method of claim 1, wherein the determining, by the computing device, based in part on the level of risk associated with the change order, one or more actions to address the incident comprises:
comparing the level of risk to a risk threshold;
determining that a first action of the one or more actions will be performed if the level of risk is greater than or equal to the risk threshold; and
determining that a second action of the one or more actions will be performed if the level of risk is less than the risk threshold.

5. The method of claim 4, wherein the first action comprises:
sending the change order to one or more computing devices associated with a change management analysis group.

6. The method of claim 4, wherein the second action comprises:
determining by the one or more machine-learning models, implementation details of the second action to resolve the incident.

7. The method of claim 1, wherein the parsing, by the computing device, using the one or more machine-learning models, the change order, wherein the parsing comprises classifying one or more terms in the incident details comprises:
applying one or more key term criteria to one or more terms of the change order, wherein the terms comprise one or more words or one or more numeric values; and
determining one or more key terms based in part on the one or more terms that satisfy the one or more key term criteria.

8. The method of claim 7, wherein the one or more key term criteria comprise a frequency of the one or more terms exceeding a term frequency threshold or the one or more terms matching one or more incident key terms.

9. The method of claim 1, further comprising:
training, using a dataset comprising historical change orders, one or more machine-learning models to determine a level of significance associated with the change order for the configuration item.

10. The method of claim 9, wherein the level of significance is associated with a number of users impacted by the change order or an estimated cost associated with the change order.

11. The method of claim 9, further comprising:
determining, by the computing device, using the one or more machine-learning models, a level of significance of the incident, wherein the one or more actions are based in part on the level of significance of the incident.

12. The method of claim 11, wherein the level of significance of the incident is based in part on the one or more terms.

13. The method of claim 12, wherein the one or more terms are associated with one or more significance values, and wherein the level of significance of the incident is positively correlated with a frequency of occurrence of the one or more terms or an aggregate of the one or more significance values of the one or more terms.

14. The method of claim 1, wherein the training, using a dataset comprising historical change orders, one or more machine-learning models to determine a level of risk associated with a change order for a configuration item comprises:
performing, by the computing device, using the one or more machine-learning models, a trend analysis of the historical change orders.

15. The method of claim 1, wherein the training, using a dataset comprising historical change orders, one or more machine-learning models to determine a level of risk associated with a change order for a configuration item comprises:
determining, by the computing device, one or more occurrences of one or more events associated with historical incidents in the historical change orders; and
correlating the one or more events with the level of risk of the historical change orders.

16. The method of claim 1, further comprising:
receiving, by the computing device, feedback associated with the one or more actions, wherein the feedback comprises an indication of which of the one or more actions were implemented or results associated with the one or more actions; and
training the one or more machine-learning models based at least in part on the feedback.

17. A non-transitory machine-readable medium storing instructions that, when executed by one or more processors, cause the one or more processors to perform steps comprising:
training, using a dataset comprising historical change orders, one or more machine-learning models to determine a level of risk associated with a change order for a configuration item;
receiving, by a computing device, a change order comprising incident details associated with an incident;
parsing, by the computing device, using the one or more machine-learning models, the change order, wherein the parsing comprises classifying one or more terms in the incident details;
determining, by the computing device, based in part on the change order and the one or more machine-learning models, the level of risk associated with the change order; and
determining, by the computing device, based in part on the level of risk associated with the change order, one or more actions to address the incident.

18. The non-transitory machine-readable medium of claim 17, wherein the instructions, when executed by one or more processors, further cause the one or more processors to perform steps comprising:
determining, using the one or more machine-learning models, a level of significance of the incident, wherein the one or more actions are based in part on the level of significance of the incident.

19. A computing device, comprising:
one or more processors; and
memory storing instructions that, when executed by the one or more processors, cause the computing device to:
train, using a dataset comprising historical change orders, one or more machine-learning models to determine a level of risk associated with a change order for a configuration item;
receive a change order comprising incident details associated with an incident;
parse, using the one or more machine-learning models, the change order, wherein the parsing comprises classifying one or more terms in the incident details;
determine, based in part on the change order and the one or more machine-learning models, the level of risk associated with the change order; and
determine, based in part on the level of risk associated with the change order, one or more actions to address the incident.

20. The computing device of claim 19, wherein the instructions, when executed by the one or more processors, further cause the computing device to:
determining, using the one or more machine-learning models, a level of significance of the incident, wherein the one or more actions are based in part on the level of significance of the incident.
